(19) United States
(12) Patent Application Publication
(10) Pub. No.: US 2025/0178902 A1
(43) Pub. Date: Jun. 5, 2025

(54) METHOD FOR PRODUCING PHOSPHORUS TRIFLUORIDE AND METHOD FOR PRODUCING PHOSPHORUS PENTAFLUORIDE

(71) Applicants: CENTRAL GLASS COMPANY, LIMITED, Ube-shi, Yamaguchi (JP); JIUJIANG TINCI MATERIALS TECHNOLOGY CO., LTD., Jiujiang, Jiangxi (CN)

(72) Inventors: Hiroki MATSUZAKI, Ube-shi, Yamaguchi (JP); Shintaro SASAKI, Ube-shi, Yamaguchi (JP); Jianjun DENG, Jiujiang, Jiangxi (CN); Du LIU, Jiujiang, Jiangxi (CN)

(73) Assignees: CENTRAL GLASS COMPANY, LIMITED, Ube-shi, Yamaguchi (JP); JIUJIANG TINCI MATERIALS TECHNOLOGY CO., LTD., Jiujiang, Jiangxi (CN)

(21) Appl. No.: 18/844,689

(22) PCT Filed: Mar. 8, 2022
(86) PCT No.: PCT/CN2022/079754

§ 371 Date: Sep. 6, 2024

(51) Int. Cl. C01B 25/10; B01J 21/18; C01B 25/455; H01M 10/0568

(52) U.S. Cl. CPC C01B 25/10; B01J 21/18; C01B 25/455; C01P 2002/82; C01P 2006/40; H01M 10/0568

(57) ABSTRACT

A method for producing phosphorus trifluoride and a method for producing phosphorus pentafluoride, which have high reaction efficiency, low reaction temperature and an excellent energy efficiency. The method includes: a step of introducing phosphorus trichloride and hydrogen fluoride into a first reactor, and a step of discharging phosphorus trifluoride from the first reactor, the first reactor contains carbon material. The method includes a step of introducing the phosphorus trifluoride obtained above and chlorine into a second reactor, and a step of discharging dichloro-phosphorus trifluoride from the second reactor. The method further includes a step of introducing the dichloro-phosphorus trifluoride obtained above and hydrogen fluoride into a third reactor; and a step of discharging phosphorus pentafluoride from the third reactor. The method further includes a step of introducing the phosphorus pentafluoride obtained above and lithium fluoride into a fourth reactor; and a step of discharging lithium hexafluorophosphate from the fourth reactor.

### TECHNICAL FIELD

The present invention relates to methods for producing phosphorus trifluoride, dichloro-phosphorus trifluoride, phosphorus pentafluoride and hexafluorophosphate, more specifically relates to methods for producing phosphorus trifluoride, dichloro-phosphorus trifluoride and phosphorus pentafluoride as raw materials for hexafluorophosphate, and a method for producing hexafluorophosphate, particularly lithium hexafluorophosphate, which can be used as an electrolyte for lithium batteries.

### BACKGROUND

In recent years, lithium-ion batteries have become more and more widely used, not only in portable devices such as mobile phones, but also in power systems of electric bicycles and electric cars, as well as energy storage systems for wind power and solar power, etc. With the emergence of many energy and environmental issues, many countries have begun to accelerate the industrial layout of new energy, smart grid and other industries, and the demand for lithium-ion batteries will grow rapidly in the future.

A solution prepared by dissolving hexafluorophosphate in a carbonate-based solvent is often used as an electrolyte for batteries because of its high conductivity, stable electrochemical performance, and ability to work at low temperatures. In particular, lithium hexafluorophosphate has the best overall performance than the other lithium salts in terms of electrical conductivity, electrochemical stability and oxidation resistance, and lithium hexafluorophosphate has many advantages such as environmental friendliness, passivation of the positive electrode current collector to prevent electrode corrosion, facilitate the formation of SEI film on the negative electrode, and a wide electrochemical stability window. In the existing lithium-ion batteries, lithium hexafluorophosphate is the most widely used electrolyte, and its quality determines the charge and discharge performance, service life and safety of the batteries. Therefore, with the increasing demand for lithium hexafluorophosphate, the research and development of LiPF₆ carbonate solution (typically LiPF₆/EMC solution) and its production method are being actively carried out.

As the existing methods for producing hexafluorophosphate, for example, methods for producing LiPF₆, the following conventional methods may be listed: a method of dissolving lithium chloride in hydrogen fluoride and then adding phosphorus pentafluoride to the former; a method for producing hexafluorophosphate by reacting a phosphorus compound with hydrofluoric acid to produce phosphorous pentafluoride, and introducing the phosphorous pentafluoride into an anhydrous hydrofluoric acid (AHF) solution of a fluorine compound (see Patent Document 1).

As a method for producing phosphorus pentafluoride, Patent Document 2 describes a method of using phosphorus trichloride as a raw material and reacting phosphorus trichloride with a molecular halogen and hydrogen fluoride.

Therefore, the preparation of phosphorus trifluoride and phosphor pentafluoride, which are raw materials of LiPF₆ carbonate solutions, has been extensively researched.

### PATENT DOCUMENTS

Patent Document 1: JP Patent No. 2987713
Patent Document 2: JP patent publication No. 2012-126621

### SUMMARY

The inventors found that there is room for improvement in the production efficiency of the above-mentioned production method disclosed by the above-mentioned Patent Documents. The present invention provides a method for producing phosphorus trifluoride, which improve the reaction efficiency and lower the reaction temperature and as a result obtain an excellent energy efficiency, a method for producing dichloro-phosphorus trifluoride, a method for producing phosphorus pentafluoride, and thereby a method for producing lithium hexafluorophosphate.

In the present invention, the following solutions are adopted to increase the reaction efficiency and lower the reaction temperature in the fluorination reaction of phosphorus trichloride, to increase the reaction efficiency in the oxidation reaction of phosphorus trifluoride.
1. A method for producing phosphorus trifluoride, comprising:
a step of introducing phosphorus trichloride and hydrogen fluoride into a first reactor; and
a step of discharging phosphorus trifluoride from the first reactor,
wherein the first reactor contains carbon material.
2. The method for producing phosphorus trifluoride according to item 1, wherein the carbon material functions as a reaction catalyst.
3. The method for producing phosphorus trifluoride according to item 1 or 2, wherein the carbon material is not loaded with any one selected from the group consisting of SbCl₅, SbF₅, SbCl₃, SbF₃, TiF₄, TiCl₄, FeCl₃ and AlCl₃.
4. The method for producing phosphorus trifluoride according to any one of items 1 to 3, wherein the carbon material is a non-loaded carbon material.
5. The method for producing phosphorus trifluoride according to any one of items 1 to 4, wherein the carbon material is activated carbon.
6. The method for producing phosphorus trifluoride according to any one of items 1 to 5, wherein the temperature in the first reactor is 100° C. to 150° C.
7. The method for producing phosphorus trifluoride according to any one of items 1 to 6, wherein the inner wall of the first reactor contains stainless steel.
8. The method for producing phosphorus trifluoride according to any one of items 1 to 6, wherein the inner wall of the first reactor includes austenitic stainless steel.
9. A method for producing dichloro-phosphorus trifluoride, comprising:
a step of introducing the phosphorus trifluoride obtained by the method for producing phosphorus trifluoride according to any one of items 1 to 8 and chlorine into a second reactor; and
a step of discharging dichloro-phosphorus trifluoride from the second reactor.
10. The method for producing dichloro-phosphorus trifluoride according to item 9, wherein the second reactor contains a filler.
11. The method for producing dichloro-phosphorus trifluoride according to item 9, wherein the second reactor contains carbon material.
12. The method for producing dichloro-phosphorus trifluoride according to item 9, wherein the second reactor contains activated carbon.
13. The method for producing dichloro-phosphorus trifluoride according to any one of items 9 to 12, wherein the inner wall of the second reactor contains a nickel-based alloy.
14. The method for producing dichloro-phosphorus trifluoride according to any one of items 9 to 12, wherein the inner wall of the second reactor contains Hastelloy.
15. A method for producing phosphorus pentafluoride, comprising:
a step of introducing the dichloro-phosphorus trifluoride obtained by the method for producing dichloro-phosphorus trifluoride according to any one of items 9 to 14 and hydrogen fluoride into a third reactor; and
a step of discharging phosphorus pentafluoride from the third reactor.
16. A method for producing phosphorus pentafluoride, comprising:
a step of introducing the phosphorus trifluoride obtained by the method for producing phosphorus trifluoride according to any one of items 1 to 8 and hydrogen fluoride into the second reactor; and
a step of discharging phosphorus pentafluoride from the second reactor.
17. A method for producing lithium hexafluorophosphate, comprising
a step of introducing the phosphorus pentafluoride obtained by the method for producing phosphorus pentafluoride according to item 15 or 16 and lithium fluoride into a fourth reactor; and
a step of discharging lithium hexafluorophosphate from the fourth reactor.

### Effects

Through the implementation of the above-mentioned technical solution of the present invention, the following advantageous effects can be achieved: the carbon material functions as a reaction catalyst, which can improve the reaction efficiency of the fluorination reaction of phosphorous trichloride and the oxidation reaction of phosphorus trifluoride, and at the same time can reduce the reaction temperature and as a result obtain an excellent energy efficiency.

### BRIEF DESCRIPTION OF THE DRAWINGS

FIG. 1 shows a schematic diagram of a device used in an embodiment of the present invention.

FIG. 2 shows FT-IR measurement results of a reaction gas discharged from reaction tube 2 of Examples 6 and 7 and Comparative Examples 6 and 7.

FIG. 3 shows pictures of a Cl₂ introduction port after the tests in Comparative Examples 8 and 9.

FIG. 4 shows analysis results of a LiPF₆/EMC concentrate obtained in Example 10.

### DETAILED DESCRIPTION

Hereinafter, the content of the present invention will be described in detail. The description of the technical features described below is based on representative embodiments and specific examples of the present invention, but the present invention is not limited to these embodiments and specific examples. It should be noted that, in this description, the numerical range represented by “numerical value A to numerical value B” refers to a range including the end values A and B.

The method for producing phosphorus trifluoride according to the present invention comprises: a step of introducing phosphorus trichloride and hydrogen fluoride into a first reactor, and a step of discharging phosphorus trifluoride from the first reactor, wherein the first reactor contains carbon material.

The method for producing dichloro-phosphorus trifluoride according to the present invention comprises: a step of introducing the phosphorus trifluoride obtained above and chlorine into a second reactor, and a step of discharging dichloro-phosphorus trifluoride from the second reactor.

The method for producing phosphorus pentafluoride according to the present invention comprises: a step of introducing the dichloro-phosphorus trifluoride obtained above and hydrogen fluoride into a third reactor, and a step of discharging phosphorus pentafluoride from the third reactor.

The method for producing lithium hexafluorophosphate according to the present invention comprises: a step of introducing the phosphorus pentafluoride obtained above and lithium fluoride into a fourth reactor, and a step of discharging lithium hexafluorophosphate from the fourth reactor.

FIG. 1 shows a schematic diagram of a device used in an embodiment of the present invention. The device comprises: a reaction tube 1, which is used to react phosphorus trichloride (PCl₃) vaporized by heating with hydrogen fluoride (HF) in the gas phase (fluorination reaction); a relay piping, which transfers the reaction gas containing phosphorus trifluoride (PF₃) to a reaction tube 2; the reaction tube 2, which makes the aforesaid reaction gas react with introduced chlorine gas (Cl₂) (oxidation reaction); an analyzer configured as required, which is configured immediately after the reaction tube 1 or immediately after the reaction tube 2 through piping and valves to sample the reaction gas and perform composition analysis on line; and a detoxification device configured as required, which detoxifies the exhaust gas.

It should be noted that the reactor 1 shown in FIG. 1 is equivalent to the first reactor of the present application, and the reactor 2 is equivalent to the second reactor of the present application. The reaction device shown in FIG. 1 is a device used for a continuous reaction in which phosphorus trichloride sequentially undergoes fluorination reaction to generate phosphorus trifluoride and undergoes oxidation reaction to generate dichloro-phosphorus trifluoride. However, it should be noted that it is also feasible to design the reaction device into a step-type reaction device for respectively implementing the method for producing phosphorous trifluoride by means of fluorination of phosphorous trichloride and the method for producing dichloro-phosphorus trifluoride by means of oxidation of phosphorous trifluoride. It is also feasible to dispose a reactor 3 (not shown) for implementing the method for producing phosphorous pentafluoride by means of fluorination of dichloro-phosphorus trifluoride, and a reactor 4 (not shown) for implementing the method for preparing lithium hexafluorophosphate from phosphorous pentafluoride, in the latter stage of the reaction device. The reactor 3 is equivalent to the third reactor of the present application, and the reactor 4 is equivalent to the fourth reactor of the present application.

In one embodiment of the present invention, phosphorus trichloride and hydrogen fluoride are introduced into the first reactor to carry out a fluorination reaction, and then phosphorous trifluoride is discharged from the first reactor, wherein the first reactor contains carbon material.

As a method of introducing phosphorus trichloride and hydrogen fluoride into the first reactor, the phosphorus trichloride and hydrogen fluoride may be heated and vaporized separately, and the gaseous phosphorus trichloride and hydrogen fluoride may be introduced separately into the first reaction. The supply amount of phosphorus trichloride gas and hydrogen fluoride gas can be easily controlled by a mass flow controller. An inert gas such as nitrogen or argon can also be used as a carrier gas as needed. The hydrogen fluoride is preferably anhydrous hydrogen fluoride from the viewpoint of preventing the phosphorus trifluoride as a product from being hydrolyzed, which may reduce the yield.

The first reactor may be equipped with a heating mantle to control the temperature of the fluorination reaction. In the conventional production methods, although the yield can be increased by extending the reaction tube and extending the gas residence time, a practical yield can be obtained only when the reaction temperature is 220° C. or higher, even 250° C. or higher. Such a high reaction temperature potentially causes an increase in energy costs. On the other hand, in the present application, carbon material is provided in the first reactor and functions as a catalyst, thereby achieving a high yield at a reaction temperature that is significantly lower than before.

The temperature for the fluorination reaction of the present invention may be set to 85° C. to 170° C., preferably 100° C. to 150° C., and more preferably 105° C. to 135° C. When the reaction temperature is lower than 85° C., sometimes a part of phosphorus trichloride may be liquefied. If a part of PCl₃ is liquefied, in a circumstance where LiPF₆/carbonate solution is produced by continuously performing the fluorination reaction in the first reactor, the oxidation reaction in the second reactor, the fluorination reaction in the third reactor, and the reaction to generate lithium hexafluorophosphate in the fourth reactor, it is difficult to control the charging ratio of PF₃>Cl₂ in the oxidation reaction, and unreacted Cl₂ becomes a cause of solvent coloration. On the other hand, when the reaction temperature exceeds 170° C., the effect of the present invention to reduce the reaction temperature by virtue of the catalytic action of carbon material becomes insignificant.

The temperature used for the heating and vaporization of phosphorus trichloride and hydrogen fluoride may be set as required, and there is no particular limitation as long as the temperature can ensure that the phosphorus trichloride and hydrogen fluoride are vaporized separately. It is preferable that phosphorus trichloride maintains a gaseous state when mixed with hydrogen fluoride in the first reactor. From the viewpoint of preventing the liquefaction of PCl₃, it is more preferable that the temperatures of the phosphorus trichloride gas and the hydrogen fluoride gas are in the same range as the aforesaid preferable range of the reaction temperature, or that the temperature of the mixed gas of the phosphorus trichloride gas and the hydrogen fluoride gas is in the same range as the aforesaid preferable range of the reaction temperature.

The reaction pressure may be atmospheric pressure, and the reaction may be carried out under increased or reduced pressure. It is preferable to carry out the reaction under atmospheric pressure in view of convenience in operation and simplification of equipment. The carbon material may include activated carbon, carbon black, graphite, graphene, carbon nanotubes, carbon nanofibers, etc., and activated carbon is preferably used.

The activated carbon preferably is activated carbon having a specific surface area of 500 to 2000 m²/g, and more preferably is activated carbon having a specific surface area of 800 to 1000 m²/g. By setting the specific surface area within the aforesaid range, the mixing of phosphorus trichloride and hydrogen fluoride can be effectively promoted, and a reaction place can be provided.

The shape of the activated carbon is not particularly limited. For example, the activated carbon may be in the form of pellets, granules, powder, or spherical particles. Granular activated carbon is preferable. As the granular activated carbon, molded carbon, microbead carbon, pulverized carbon, and granulated carbon may be used. From the viewpoint of the filling of activated carbon in the reactor and its function as a catalyst, the particle size of the granular activated carbon is preferably 0.1 to 40 mm, more preferably 0.2 to 25 mm, and even more preferably 0.3 to 10 mm.

The type of activated carbon is not particularly limited, and a commercially available product may be used, or activated carbon previously activated may also be used. Examples of the activation method of activated carbon include a gas activation method and a chemical activation method. Examples of commercially available activated carbons include Shirasagi (trademark) manufactured by Osaka Gas Chemicals Co., Ltd., Filtrasorb (trademark) CAL, DIAHOPE (trademark), DIASORB (trademark), etc. manufactured by Calgon Carbon Japan KK., EBADIA (trademark) series manufactured by Swing Corporation, KURARAY COAL (trademark) series, BPL manufactured by Kuraray Co., Ltd., KURICOAL (trademark) series manufactured by Kurita Water Industries Ltd., PL series, PG series, PGN series, PGD series, manufactured by DAINEN Co., Ltd., etc.

The carbon material of the present invention exerts a catalytic effect by itself. Therefore, from the viewpoint of ensuring the catalytic effect of carbon material and reducing the costs, the carbon material is preferably a non-loaded carbon material. Compared with the loaded carbon material in which part of the voids are blocked while loading catalyst, the un loaded carbon material may has a larger specific surface area, and thus can more effectively ensure the catalytic effect of the carbon material. The carbon material is for example, carbon material not loaded with SbCl₅, SbF₅, SbCl₃, SbF₃, TiF₄, TiCl₄, FeCl₃ and/or AICl₃, and more preferably a non-loaded activated carbon, such as activated carbon not loaded with SbCl₅, SbF₅, SbCl₃, SbF₃, TiF₄, TiCl₄, FeCl₃ and/or AlCl₃.

The shape of the first reactor is not particularly limited, typically including a reaction tube, a reaction kettle, a reaction tower, and the like. The material of the reactor can be selected from materials resistant to HF, including nickel, nickel alloys, and stainless steel. Examples of the nickel alloy include Monel (registered trademark) alloy and Hastelloy (registered trademark) alloy which mainly contain nickel and copper, and also contain iron, manganese, or sulfur. Examples of the stainless steel include austenitic stainless steel such as SUS304 and SUS316. From the viewpoint of balancing cost and resistance to corrosion, the first reactor is preferably a reaction tube made of stainless steel. The first reactor may be entirely composed of stainless steel, or only the inner wall is composed of stainless steel.

In the present invention, the product gas discharged from the first reactor is a mixed gas of phosphorus trifluoride, hydrogen chloride and hydrogen fluoride, etc., but the product gas can be used directly if the impurity gases such as hydrogen chloride and hydrogen fluoride do not cause a problem. For example, the product gas can be directly supplied for the oxidation reaction in the second reactor. In addition, the above-mentioned impurity gases may also be removed to provide high-purity phosphorus trifluoride.

In one embodiment of the present invention, the phosphorus trifluoride-containing reaction gas discharged from the first reactor and chlorine gas are introduced into the second reactor, and dichloro-phosphorus trifluoride is discharged from the second reactor.

As found by the inventors, when the reaction gas discharged from the first reactor is used to carry out the oxidation reaction in the second reactor, if the fluorination reaction rate of the reaction gas is low, the oxidation reaction rate increases. It is considered that this is because when the fluorination reaction rate in the first reactor is low, the high boiling components such as unreacted PCl₃ remaining in the reaction gas liquefies in the second reactor at a low temperature and sufficiently reacts with Cl₂ in the liquid phase, and the oxidation reaction rate increases. In fact, however, when a reaction gas with a low fluorination reaction rate is used, solids such as PCl₅ are likely to be precipitated at the chlorine gas blowing inlet, which can block the gas flow path in severe cases. Therefore, it is unrealistic to reduce the fluorination reaction rate so as to increase the oxidation reaction rate.

In addition, as found by the inventors, it is important to stably keep a PF₃ concentration higher than Cl₂ in the second reactor. If the fluorination of PCl₃ in the first reactor is sufficient, the clogging of the reaction tube caused by liquefaction of PCl₃ and solid PCl₅ can be suppressed in the subsequent stages, and it is easy to stabilize the above-mentioned the condition that the PF₃ concentration is higher than Cl₂. In an ideal embodiment, 100% of the raw material is converted into low-boiling PF₃ in the first reactor. Increasing the fluorination efficiency as in this application will produce advantages such as miniaturization of the reactor and improved energy efficiency.

On the other hand, if the fluorination reaction rate in the first reactor is high, the phosphorus component in the reaction gas is mainly low-boiling PF₃, so the reaction with Cl₂ in the second reactor is a complete gas phase system, which greatly reflects the influence of gas stirring efficiency, and as a result, the oxidation reaction rate is reduced.

In order to increase the oxidation reaction rate while preventing blocking in the second reactor, it is preferable to fill the second reactor with a filler. Examples of such fillers include Berl Saddle filler, McMahon filler, Dixon filler, Raschig Ring, Pall Ring, Heilex Ring, Teller Rosette, IMPAC filler, Helipack filler, carbon material, etc.

As the above-mentioned filler, Carbon material and Metallic filler such as Helipack filler are more preferable from the viewpoint of further increasing the oxidation reaction rate. A preferable form and example of carbon material may refer to the aforesaid preferable form and example of carbon material used in the first reactor.

The shape and material of the second reactor are not particularly limited, and a preferable form and example thereof may refer to the aforesaid preferable form and example of the shape and material of the first reactor.

The temperature of the oxidation reaction in the second reactor is not particularly limited. For example, the reaction can be carried out at any temperature in the range of 15° C. to 60° C., preferably 20° C. to 50° C. It is preferable to carry out the reaction at room temperature in view of convenience in operation and simplification of equipment. In addition, it can also be equipped with a heating mantle or a cooling device to control the temperature of the oxidation reaction.

The reaction pressure may be atmospheric pressure, or the reaction may be carried out under increased or reduced pressure. It is preferable to carry out the reaction under atmospheric pressure in view of convenience in operation and simplification of equipment.

In a circumstance where LiPF₆/carbonate solution is prepared by using phosphorus pentafluoride generated by reacting a dichloro-phosphorus trifluoride-containing reaction gas discharged from the second reactor with hydrogen fluoride, from the viewpoint of preventing unreacted Cl₂ from causing solvent coloration to the final product, it is preferable to strictly control the charging ratio of PF₃>Cl₂ in the oxidation reaction. Since the Cl₂ charge equivalent is directly related to the yield, it is better to be as close as possible to 1.0 eq. From the viewpoint of ensuring that the yield does not decrease, the Cl₂ charge equivalent is usually 0.85 eq. or more, and preferably 0.90 eq. or more with respect to PF₃. On the other hand, since the charging ratio is also affected by the charging accuracy of the raw material gas, in order to ensure the charging ratio of PF₃>Cl₂, it is preferable to carry out the oxidation reaction in the second reactor in a condition that the Cl₂ charge equivalent is 0.97 eq. or less, and preferably 0.95 eq. or less with respect to PF₃.

In the present invention, the product gas discharged from the second reactor is a mixed gas of dichloro-phosphorus trifluoride, phosphorus trifluoride and hydrogen chloride, etc., but the product gas can be used directly if the impurity gases such as phosphorus trifluoride and hydrogen chloride do not cause a problem. For example, the product gas can be directly supplied for the fluorination reaction in the third reactor. In addition, the above-mentioned impurity gases may also be removed to provide high-purity dichloro-phosphorus trifluoride.

In one embodiment of the present invention, the reaction gas containing dichloro-phosphorus trifluoride discharged from the second reactor and hydrogen fluoride are introduced into the third reactor, and phosphorus pentafluoride is discharged from the third reactor.

The shape and material of the third reactor are not particularly limited, as long as the dichloro-phosphorus trifluoride-containing reaction gas discharged from the second reactor can be contacted and reacted with hydrogen fluoride. The preferable forms and examples of the third reactor may refer to the aforesaid preferable form and example of the first reactor. In addition, the third reactor may also use an AHF scrubber.

Reaction conditions such as the temperature of the fluorination reaction in the third reactor may refer to known methods. The hydrogen fluoride may be in any form of gas, liquid, and solution, which is not particularly limited.

In the present invention, the product gas discharged from the third reactor is a mixed gas of phosphorus pentafluoride, hydrogen fluoride, hydrogen chloride, chlorine, etc., but the product gas can be used directly if the impurity gases such as hydrogen fluoride, hydrogen chloride, chlorine do not cause a problem. For example, the product gas can be directly supplied for the reaction in the fourth reactor. In addition, the above-mentioned impurity gases may also be removed to provide high-purity phosphorus pentafluoride.

In one embodiment of the present invention, the phosphorus pentafluoride-containing reaction gas discharged from the third reactor and lithium fluoride are introduced into the fourth reactor, and lithium hexafluorophosphate is discharged from the fourth reactor.

Reaction conditions such as the temperature of the reaction in the fourth reactor may refer to known methods. The lithium fluoride introduced into the fourth reactor may be in any form of powder, dispersion, and suspension. When the carbonate solvent is also introduced into the fourth reactor, lithium hexafluorophosphate may be discharged from the fourth reactor in the form of a carbonate solution of lithium hexafluorophosphate. Particularly, when ethyl methyl carbonate (EMC) is used, the product obtained from the fourth reactor may be a lithium hexafluorophosphate/EMC solution.

The carbonate solution of lithium hexafluorophosphate discharged from the fourth reactor may be degassed as needed. The degassed lithium hexafluorophosphate/EMC solution may be directly used to prepare the electrolyte solution of the lithium battery and may also be concentrated as needed and provided in the form of a lithium hexafluorophosphate/EMC concentrated solution. In order to meet the index of free acid, the aforesaid solution may be diluted one or more times and then concentrated as needed. The operation and conditions of degassing and concentration may refer to known methods.

It should be noted that the reactions in the first reactor, the second reactor, the third reactor and the fourth reactor are separately described above, but it should be clear that the plurality of reactions carried out in continuous reactors may be combined and carried out in the same reactor as needed. For instance, the product gas discharged from the first reactor, chlorine gas, and hydrogen fluoride may be introduced into the second reactor together, so that not only the oxidation reaction of phosphorus trifluoride but also at least a part of the fluorination reaction of fluorochloride of pentavalent phosphorus are carried out.

When the lithium hexafluorophosphate/EMC concentrate is produced by the method of the present invention, the yield of lithium hexafluorophosphate is high, and solvent coloration caused by unreacted chlorine is suppressed, and a lithium hexafluorophosphate/EMC concentrate that meets industrial standards can be obtained.

### EXAMPLES

Examples of the present invention are described below, but the present invention is not limited to the following examples.

The reaction device used in the Examples was configured as shown in FIG. 1, wherein SUS316L BA tube (φ=¼ inch) was used as the reaction tube, which was heated to a required temperature with a heating belt during the reaction. The analyzer was a Fourier Transform Infrared Spectrometer (FT-IR), which performed quantitative analysis using peak height. The specific measurement conditions were as follows.

### FT-IR Measurement Conditions

installation: Prestige-21 manufactured by Shimadzu Corporation
length of gas sample cell: 10 cm
material of sample cell window: ZnSe
measurement mode: Absorbance
cumulative times: 100 times

### Determination Peaks:

HF: 4037.01 cm⁻¹ (determination range: 2054.37 to 4021.58 cm⁻¹)
HCl: 2819.93 cm⁻¹ (determination range: 2810.28 to 2829.57 cm⁻¹)
PF₃: 904.61 cm⁻¹ (determination range: 740.67 to 1099.43 cm⁻¹)

### Example 1

Phosphorus trichloride gas and anhydrous hydrogen fluoride gas heated to 120° C. were supplied to reaction tube 1 (the first reactor) at a rate of 11.9 sccm and 52.3 sccm, respectively [equivalent ratio (AHF/PCl₃)=4.4] to carry out reaction. The reaction conditions are shown in Table 1 below, wherein the reaction tube 1 was filled with 2 g of granular Shirasagi LH2c (Osaka Gas Chemicals Co., Ltd.) as activated carbon. FT-IR was used to perform quantitative analysis on the reaction gas discharged from the reaction tube 1. The PF₃ yield became stable after 60 minutes from the start of the reaction. The value at this time was recorded in Table 1 as the PF₃ yield.

### Examples 2 to 5 and Comparative Examples 1 to 5

Except that the charging conditions and reaction conditions were changed as in Table 1, the reaction was performed in the same manner as in Example 1, the PF₃ yield was quantitatively analyzed, and the results were shown in Table 1 below.

TABLE 1

| | | | | Reaction conditions | | | | | | |
|---|---|---|---|---|---|---|---|---|---|---|
| | | | | | Length of | | superficial | | | |
| | charging conditions | | | Diameter of | reaction | Residence | linear | reaction | | PF₃ |
| | PCl₃ | AHF | | reaction tube | tube | time | velocity | temperature | | yield |
| | [sccm] | [sccm] | [eq.] | [inch] | [mm] | [s] | [m/min] | [° C.] | Filler | [%] |
| Example 1 | 11.9 | 52.3 | 4.4 | ¼ | 680 | 6.7 | 6.1 | 120 | granular | 108.9 |
| | | | | | | | | | Shirasagi LH2c | |
| Example 2 | 12.0 | 61.0 | 5.1 | ¼ | 680 | 3.4 | 1.23 | 120 | activated carbon | 104.6 |
| | | | | | | | | | BPL | |
| Example 3 | 12.0 | 61.0 | 5.1 | ¼ | 680 | 3.4 | 1.23 | 120 | KURARAY | 112.6 |
| | | | | | | | | | COAL | |
| | | | | | | | | | KW20/40 | |
| Example 4 | 11.8 | 61.0 | 5.2 | ¼ | 680 | 3.4 | 1.22 | 120 | KURARAY | 111.3 |
| | | | | | | | | | COAL 3GG | |
| Example 5 | 12.6 | 61.0 | 4.8 | ¼ | 680 | 3.4 | 1.24 | 120 | KURICOAL | 112.8 |
| | | | | | | | | | WG-765 | |
| Comparative | 12.3 | 48.4 | 3.9 | ¼ | 680 | 5.6 | 7.3 | 220 | — | 18.6 |
| Example 1 | | | | | | | | | | |
| Comparative | 11.4 | 48.4 | 4.2 | ¼ | 680 | 5.7 | 7.1 | 220 | Helipack No.2 | 20.4 |
| Example 2 | | | | | | | | | | |
| Comparative | 10.7 | 48.4 | 4.5 | ¼ | 1660 | 14.1 | 7.1 | 220 | — | 37.9 |
| Example 3 | | | | | | | | | | |
| Comparative | 12.0 | 61.0 | 5.1 | ¼ | 680 | 3.4 | 1.23 | 120 | — | 42.1 |
| Example 4 | | | | | | | | | | |
| Comparative | 10.7 | 48.4 | 4.5 | ¼ | 1660 | 14.1 | 7.4 | 240 | — | 62.0 |
| Example 5 | | | | | | | | | | |

Information on the fillers used in the respective examples is shown in Table 2 below.

TABLE 2

| | | | | Particle | Charging |
|---|---|---|---|---|---|
| | | | | size | weight |
| | Fillers | Types | Manufacturers | [mm] | [g] |
| Example 1 | granular Shirasagi | Pulverized | Osaka Gas | 0.300 to | 2 |
| | LH2c | charcoal | Chemicals Co., Ltd. | 0.850 | |
| Example 2 | Activated carbon | Pulverized | Kuraray Co., Ltd. | 2.00 to | 2.17 |
| | BPL | charcoal | | 4.75 | |
| Example 3 | KURARAY | Pulverized | Kuraray Co., Ltd. | 0.355 to | 3.48 |
| | COAL KW20/40 | charcoal | | 0.850 | |
| Example 4 | KURARAY | Granulated | Kuraray Co., Ltd. | 2.36 to | 2.25 |
| | COAL 3GG | charcoal | | 3.35 | |
| Example 5 | KURICOAL WG- | Pulverized | Kurita Water | 0.355 to | 3.02 |
| | 765 | charcoal | Industries Ltd. | 0.850 | |
| Comparative | Helipack No. 2 | SUS316L- | SIBATA | 2.5 | 13.97 |
| Example 2 | | filler | SCIENTIFIC | | |
| | | | TECHNOLOGY | | |
| | | | LTD | | |

As shown in Table 1, Examples 1-5 using activated carbon all achieved a high PF₃ yield of about 100%. On the other hand, Comparative Example 4, which did not use any filler in the reaction tube, had a low PF₃ yield. Furthermore, in Comparative Examples 1 to 3 that did not use activated carbon as a filler, the PF₃ yield was low even if the reaction temperature was increased to 220° C. to provide conditions more favorable for the production of PF₃. As compared with Comparative Example 1 in which no filler was used, in Comparative Example 2 in which a filler other than carbon material (activated carbon) was used, no significant improvement in the PF₃ yield was observed. As compared with Comparative Example 1, in Comparative Example 3 in which the residence time was extended by lengthening the reaction tube, the PF₃ yield was slightly improved, but the high yield of the Example level was not obtained. In Comparative Example 5, the residence time was extended by lengthening the reaction tube, and meanwhile the reaction temperature was increased to 240° C., but the PF₃ yield only increased to 62.0%, which still did not achieve the high yield of the Example level.

### Example 6

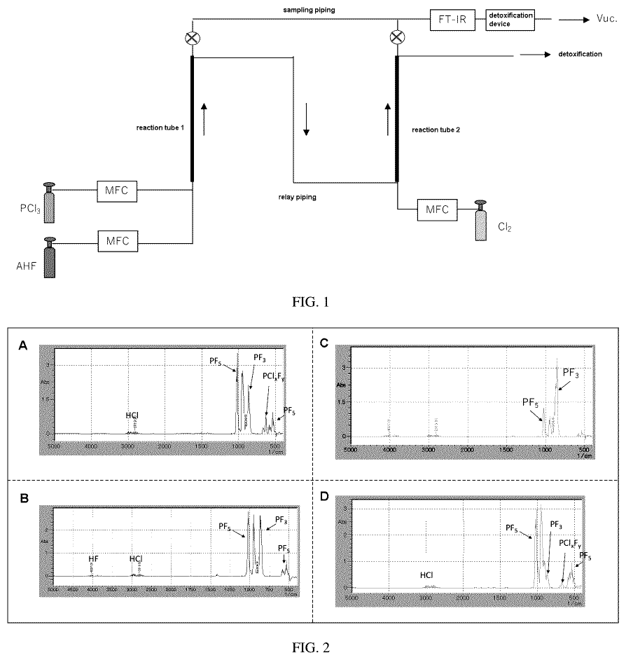

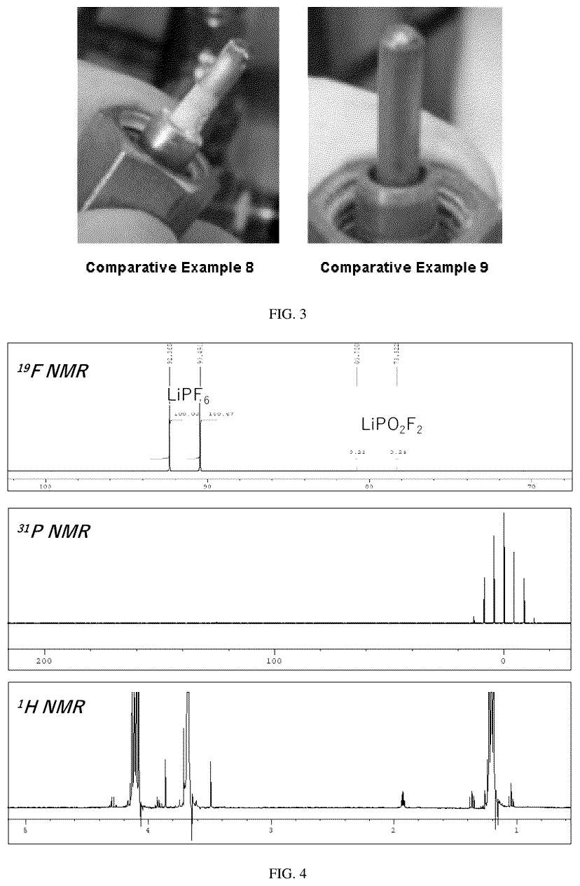

The reaction gas with a PF₃ yield of 100% containing unreacted hydrogen fluoride gas, obtained by reacting phosphorus trichloride gas and anhydrous hydrogen fluoride gas in reaction tube 1 (the first reactor) is discharged from reaction tube 1 and introduced to reaction tube 2 (the second reactor), to which chlorine gas was introduced, and had the reaction gas undergo oxidation reaction and fluorination reaction. FT-IR was used to perform composition analysis on the reaction gas discharged from the reaction tube 2, and the result was shown by B in FIG. 2. The reaction tube 2 was filled with Helipack No. 2.

### Example 7

Except that the reaction tube 2 was filled with activated carbon instead of Helipack No. 2, the same operation was performed as in Example 6, and the composition analysis result of the reaction gas discharged from the reaction tube 2 was shown by D in FIG. 2.

### Comparative Example 6

Except that the PF₃ yield was changed to 60% and the reaction tube 2 was not filled with any filler, the same operation was performed as in Example 6, and the composition analysis result of the reaction gas discharged from the reaction tube 2 was shown by A in FIG. 2.

### Comparative Example 7

Except that the reaction tube 2 was not filled with any filler, the same operation was performed as in Example 6, and the composition analysis result of the reaction gas discharged from the reaction tube 2 was shown by C in FIG. 2.

As shown by FIG. 2, phosphor pentafluoride was significantly produced in Examples 6 and 7 which used a reaction gas with a PF₃ yield of 100% as a raw material and in which the reaction tube 2 was filled with a filler. As compared with Example 6 using Helipack No. 2, in Example 7, the conversion rate of phosphorous trifluoride was high, and the yield of phosphorous pentafluoride was improved.

On the other hand, in Comparative Example 6, which used a reaction gas with a PF₃ yield of 60% as a raw material and in which no filler was filled, phosphor pentafluoride was significantly produced. However, blocking occurred within a period of time after the start of the reaction, so the reaction failed to proceed stably for a long time. In addition, in Comparative Example 7, which used a reaction gas with a PF₃ yield of 100% as a raw material, and in which no filler was filled, the production amount of phosphor pentafluoride was small.

### Example 8 and 9, Comparative Examples 8 and 9

Phosphorus trichloride gas and anhydrous hydrogen fluoride gas reacted in the reaction tube 1 under the fluorination reaction conditions shown in Table 3, and the PF₃ yield of the reaction gas discharged from the reaction tube 1 was measured and recoded in Table 3. Chlorine gas and the reaction gas containing unreacted hydrogen fluoride gas were introduced into the reaction tube 2 (the second reactor) to react under the oxidation reaction conditions shown in Table 4, the presence or absence of a precipitate at the chlorine gas inlet was observed. The results were shown in Table 4.

TABLE 3

| | | | | Reaction conditions | | | | | | |
|---|---|---|---|---|---|---|---|---|---|---|
| | | | | | Length of | | superficial | | | |
| | Charging conditions | | | Diameter of | reaction | Residence | linear | reaction | | PF₃ |
| | PCl₃ | AHF | | reaction tube | tube | time | velocity | temperature | | yield |
| | [sccm] | [sccm] | [eq.] | [inch] | [mm] | [s] | [m/min] | [° C.] | Filler | [%] |
| Example 8 | 12.1 | 52.3 | 4.3 | ¼ | 680 | 6.7 | 6.1 | 120 | granular | About |
| | | | | | | | | | Shirasagi | 100 |
| | | | | | | | | | LH2c | |
| Example 9 | 11.8 | 61.0 | 5.2 | ¼ | 680 | 5.9 | 6.9 | 120 | granular | About |
| | | | | | | | | | Shirasagi | 100 |
| | | | | | | | | | LH2c | |
| Comparative | 11.3 | 48.4 | 4.3 | ¼ | 680 | 6.2 | 5.7 | 120 | — | 36.5 |
| Example 8 | | | | | | | | | | |
| Comparative | 11.3 | 52.3 | 4.6 | ¼ | 1660 | 3.4 | 1.23 | 240 | — | 59.4 |
| Example 9 | | | | | | | | | | |

TABLE 4

| | | | Reaction conditions | | | | | | |
|---|---|---|---|---|---|---|---|---|---|
| | Charging | | Diameter of | Length of | | superficial | | | |
| | conditions | | reaction | reaction | Residence | linear | Reaction | | |
| | Cl₂ | | tube | tube | time | velocity | temperature | | precipitate |
| | [sccm] | [eq.] | [inch] | [mm] | [s] | [n/min] | [° C.] | Fillers | [%] |
| Example 8 | 11.0 | 0.9 | ¼ | 680 | 7.4 | 5.5 | Room | granular | No |
| | | | | | | | temperature | Shirasagi | |
| | | | | | | | | LH2c | |
| Example 9 | 11.0 | 0.9 | ¼ | 680 | 6.6 | 6.2 | Room | granular | No |
| | | | | | | | temperature | Shirasagi | |
| | | | | | | | | LH2c | |
| Comparative | 26.0 | 2.3 | ¼ | 680 | 5.5 | 6.3 | Room | — | Yes |
| Example 8 | | | | | | | temperature | | (blocking) |
| Comparative | 10.3 | 0.9 | ¼ | 680 | 7.5 | 5.4 | Room | — | Yes |
| Example 9 | | | | | | | temperature | | |

From Tables 3 and 4, it can be seen that in Example 8 and 9 in which the fluorination reaction was 100% and activated carbon was filled in the reaction tube 2, no precipitate was confirmed in the vicinity of the Cl₂ introduction port. On the other hand, as shown in FIG. 3, blocking occurred during the reaction in Comparative Example 8 with a low fluorination reaction rate. When the experiment was interrupted and the device was opened for inspection, a white crystal was confirmed near the Cl₂ inlet. The crystal was hygroscopic and acidic, so it was considered to be PCl₅ produced from unreacted PCl₃ and Cl₂. In addition, in Comparative Example 9 in which the fluorination reaction rate was about 60%, blocking of the reaction tube 2 did not occur, but some crystal precipitation was confirmed in the vicinity of the Cl₂ introduction port.

### Example 10

Under the same fluorination reaction conditions as in Example 9, phosphorus trichloride gas and anhydrous hydrogen fluoride gas reacted in the reaction tube 1. The reaction gas containing unreacted hydrogen fluoride gas discharged from the reaction tube 1 and chlorine gas were introduced into the reaction tube 2 (the second reactor) to carry out the oxidation reaction and fluorination reaction under the same conditions as in Example 9 to generate phosphorus pentafluoride. The reaction production discharged from the reaction tube 2 was introduced into a gas trapping vessel (the fourth reactor) containing a 2.4 wt % lithium fluoride EMC solution. Here, the 2.4 wt % lithium fluoride EMC solution was a mixture of 200 g EMC and 5 g (1.9 eq.) LiF, and gas trapping was performed for 210 minutes under an ice-cold condition. After the gas trapping was completed, the solution in the gas trapping vessel was degassed for 1 hour under an ice-cold condition, and then placed to return to room temperature, followed by degassing for 0.5 hour, to obtain 216.01 g of the degassed solution. The degassed solution was concentrated under reduced pressure at 60° C. for 0.5 hour to obtain 40.23 g of a concentrated solution. The concentrated solution was filtered under pressure using a 0.5 μm PTFE membrane, the filter residue was washed with EMC, and the filtrate was combined to finally obtain a 33% LiPF6/EMC concentrated solution. The analysis results of the 33% LiPF6/EMC concentrated solution were shown in Table 5.

TABLE 5

| | | | | | Free acid [ppm] | | APHA chromaticity | |
|---|---|---|---|---|---|---|---|---|
| Weight | Concentration | Yield | ¹⁹F NMR | | Measured | 1M | Measured | 1M |
| [g] | [wt %] | [%] | LiPF₆ | LiPO₂F₂ | value | conversion | value | conversion |
| 47.4 | 32.7% | 97.8% | 99.3% | 0.7% | 118 | 43 | 98 | 36 |

In Example 10, the yield of LiPF₆ was good at 97.8%, the solvent coloring caused by unreacted Cl₂ was also suppressed. The ¹⁹F NMR result showed 0.7% LiPO₂F₂, which, as believed, was caused by the residual moisture in the gas trapping vessel.

### INDUSTRIAL AVAILABILITY

In accordance with the present invention, a method for producing a phosphorus trifluoride and a method for producing a phosphorus pentafluoride are provided, which have high reaction efficiency, low reaction temperature and can prevent blocking of the reactors, and are suitable for the industrial manufacture of LiPF₆/EMC concentrate.

The respective examples of the present invention have been described above, and the above description is exemplary and not exhaustive. The present invention is not limited to the disclosed examples. Without departing from the scope and concept of the described examples, many modifications and changes are obvious to ordinary skilled persons in the art.

1-17. (canceled)

18. A method for producing phosphorus trifluoride, comprising:
a step of introducing phosphorus trichloride and hydrogen fluoride into a first reactor; and
a step of discharging phosphorus trifluoride from the first reactor,
wherein the first reactor contains carbon material.

19. The method for producing phosphorus trifluoride according to claim 18, wherein the carbon material functions as a reaction catalyst.

20. The method for producing phosphorus trifluoride according to claim 18, wherein the carbon material is not loaded with any one selected from the group consisting of SbCl₅, SbF₅, SbCl₃, SbF₃, TiF₄, TiCl₄, FeCl₃ and AlCl₃.

21. The method for producing phosphorus trifluoride according to claim 18, wherein the carbon material is a non-loaded carbon material.

22. The method for producing phosphorus trifluoride according to claim 18, wherein the carbon material is activated carbon.

23. The method for producing phosphorus trifluoride according to claim 18, wherein the temperature in the first reactor is 100° C. to 150° C.

24. The method for producing phosphorus trifluoride according to claim 18, wherein the inner wall of the first reactor contains stainless steel.

25. The method for producing phosphorus trifluoride according to claim 18, wherein the inner wall of the first reactor includes austenitic stainless steel.

26. A method for producing dichloro-phosphorus trifluoride, comprising:
a step of introducing the phosphorus trifluoride obtained by the method for producing phosphorus trifluoride according to claim 18 and chlorine into a second reactor; and
a step of discharging dichloro-phosphorus trifluoride from the second reactor.

27. The method for producing dichloro-phosphorus trifluoride according to claim 26, wherein the second reactor contains a filler.

28. The method for producing dichloro-phosphorus trifluoride according to claim 26, wherein the second reactor contains carbon material.

29. The method for producing dichloro-phosphorus trifluoride according to claim 26, wherein the second reactor contains activated carbon.

30. The method for producing dichloro-phosphorus trifluoride according to claim 26, wherein the inner wall of the second reactor contains a nickel-based alloy.

31. The method for producing dichloro-phosphorus trifluoride according to claim 26, wherein the inner wall of the second reactor contains Hastelloy.

32. A method for producing phosphorus pentafluoride, comprising:
a step of introducing the dichloro-phosphorus trifluoride obtained by the method for producing dichloro-phosphorus trifluoride according to claim 26 and hydrogen fluoride into a third reactor; and
a step of discharging phosphorus pentafluoride from the third reactor.

33. A method for producing phosphorus pentafluoride, comprising:
a step of introducing the phosphorus trifluoride obtained by the method for producing phosphorus trifluoride according to claim 18, chlorine gas, and hydrogen fluoride into the second reactor; and
a step of discharging phosphorus pentafluoride from the second reactor.

34. A method for producing lithium hexafluorophosphate, comprising
a step of introducing the phosphorus pentafluoride obtained by the method for producing phosphorus pentafluoride according to claim 32 and lithium fluoride into a fourth reactor; and
a step of discharging lithium hexafluorophosphate from the fourth reactor.
